(19) United States
(12) Patent Application Publication
(10) Pub. No.: US 2009/0117301 A1
(43) Pub. Date: May 7, 2009

(54) Resilient shock-absorbing device

(76) Inventor: Keng-Hsien Lin, Kaohsiung City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/982,559

(22) Filed: Nov. 1, 2007

(51) Int. Cl. B32B 1/08; B32B 27/40

(52) U.S. Cl. 428/35.7; 428/34.1

(57) ABSTRACT

A resilient shock-absorbing device includes at least one layer of a composite unit including top and bottom faces, and a plurality of juxtaposed and interconnected resilient elongate members disposed between the top and bottom faces. Each of the resilient elongate members has an outer tube, and a foam member disposed in the outer tube and extending along the length of the outer tube.

### BACKGROUND OF THE INVENTION

1. Field of the Invention

This invention relates to a shock-absorbing device, more particularly to a shock-absorbing device made from thermoplastic polyurethane.

2. Description of the Related Art

Referring to FIG. 1, a conventional sports shoe 1 includes a main body 11, and an air-filled plastic cushion 12 provided in a bottom portion of the main body 11 so as to absorb the weight of the wearer's body and the ground impact during use of the sports shoe 1. As such, the stress on the wearer's foot is minimized.

Although the air-filled plastic cushion 12 of the sports shoe 1 provides a shock-absorbing effect, its softness and supporting force still need improvement. Further, the plastic cushion 12 is made of more than one kind of material, so that interconnection among the different materials is poor. This leads to difficulty in the succeeding processing steps. Also, the plastic cushion 12 is not breathable, so that air ventilation is not provided in the foot portion, thereby reducing wear comfort of the sports shoe 1. Moreover, when the plastic cushion 12 is damaged, the buffering and shock-absorbing functions of the sports shoe 1 are lost. When the damaged plastic cushion 12 is thrown away, it causes environmental contamination because it cannot be recycled.

### SUMMARY OF THE INVENTION

Therefore, the object of the present invention is to provide a resilient shock-absorbing device that is made from thermoplastic polyurethane and that can effectively buffer an external force so as to provide enhanced comfort and a good shock-absorbing effect.

According to this invention, a resilient shock-absorbing device comprises at least one layer of a composite unit including top and bottom faces, and a plurality of juxtaposed and interconnected resilient elongate members disposed between the top and bottom faces. Each of the resilient elongate members has an outer tube, and a foam member disposed in the outer tube and extending along the length of the outer tube.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional sports shoe;

FIG. 2 is a schematic view of the first preferred embodiment of a resilient shock-absorbing device according to the present invention, illustrating application of the first preferred embodiment to a sole portion of a shoe;

FIG. 3 is a perspective view of the first preferred embodiment;

FIG. 4 is a perspective view of a resilient shock-absorbing device according to the second preferred embodiment of the present invention;

FIG. 5 is a perspective view of a resilient shock-absorbing device according to the third preferred embodiment of the present invention;

FIG. 6 illustrates an alternative form of the resilient shock-absorbing device of the third preferred embodiment; and

FIG. 7 is a perspective view of a resilient shock-absorbing device according to the fourth preferred embodiment of the present invention.

### DETAILED DESCRIPTION OF THE PREFERRED EMBODIMENTS

Before the present invention is described in greater detail, it should be noted that the same reference numerals have been used to denote like elements throughout the specification.

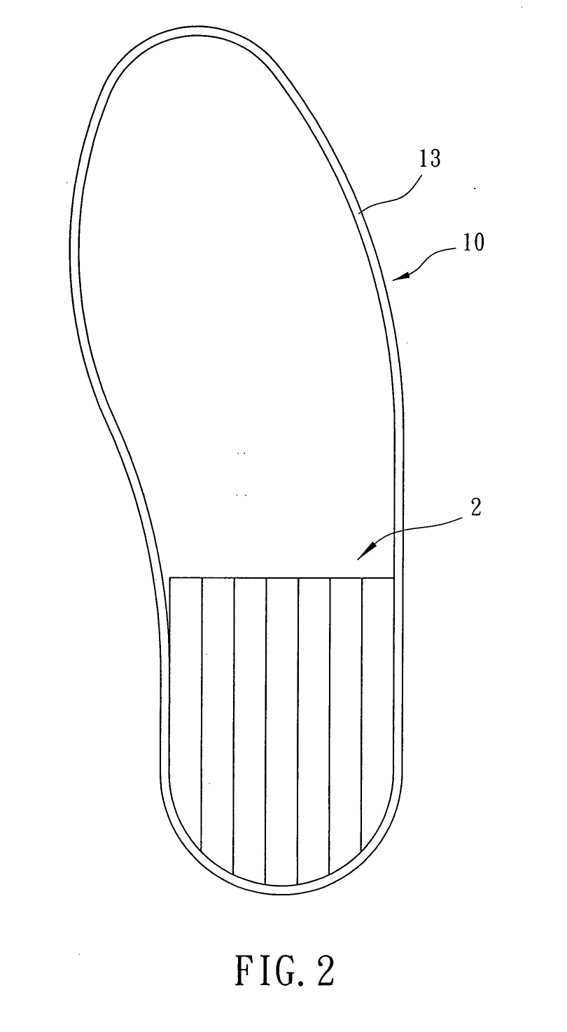

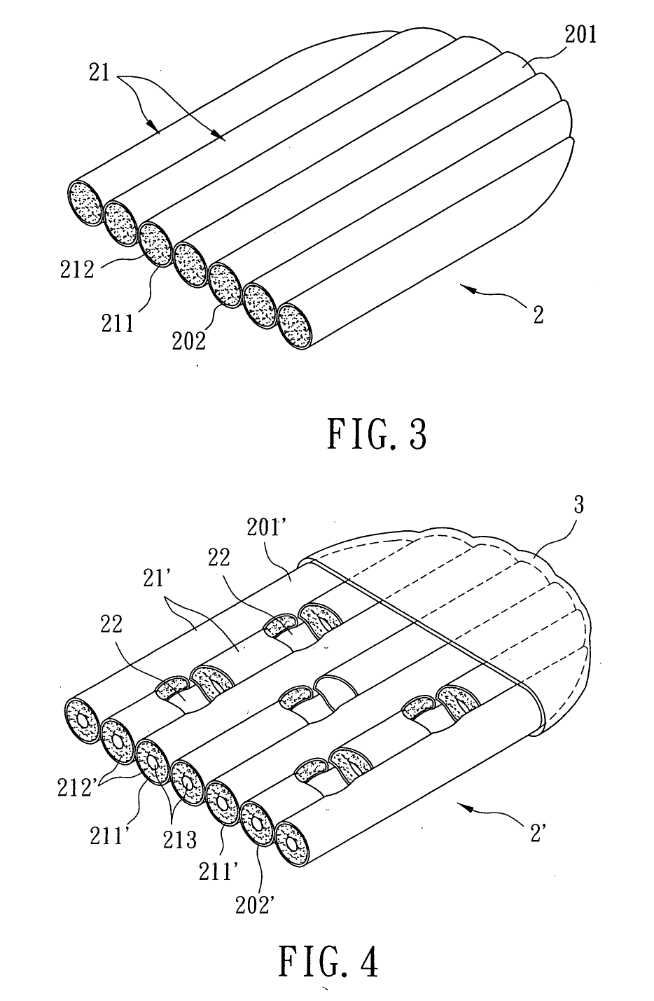

Referring to FIGS. 2 and 3, a resilient shock-absorbing device according to the first preferred embodiment of the present invention is adapted to be installed in a sole portion 13 of a shoe 10, and is shown to comprise a single layer of a composite unit 2. In actual practice, the resilient shock-absorbing device of the present invention may be installed in other products that need shock-absorbing protection, such as a protective suit, a safety helmet, different protective pads used in sports, etc., and is thus not limited to the disclosed embodiment.

In this embodiment, the composite unit 2 has top and bottom faces 201, 202, and includes a plurality of juxtaposed and interconnected first resilient elongate members 21 disposed between the top and bottom faces 201, 202. Each of the first resilient elongate members 21 has a first outer tube 211, and a first foam member 212 disposed in the first outer tube 211 and extending along the length thereof. The first outer tube 211 and the first foam member 212 are made of thermoplastic polyurethane and may be made by extrusion or any other suitable process. The hardness of the first outer tube 211 ranges from55 ShoreA to 85 ShoreD. The density of the first foam member 212 ranges from 0.2 g/cm³ to 0.6 g/cm³. The first resilient elongate members 21 may be interconnected by adhesive bonding or high-frequency welding.

As shown in FIG. 3, the first outer tubes 211 of the first resilient elongate members 21 are interconnected in such a manner that they are parallel to each other. Since the first outer tube 211 and the first foam member 212 of each first resilient elongate member 21 are made of the same material, they can be tightly bonded to each other, and are therefore not easily separated.

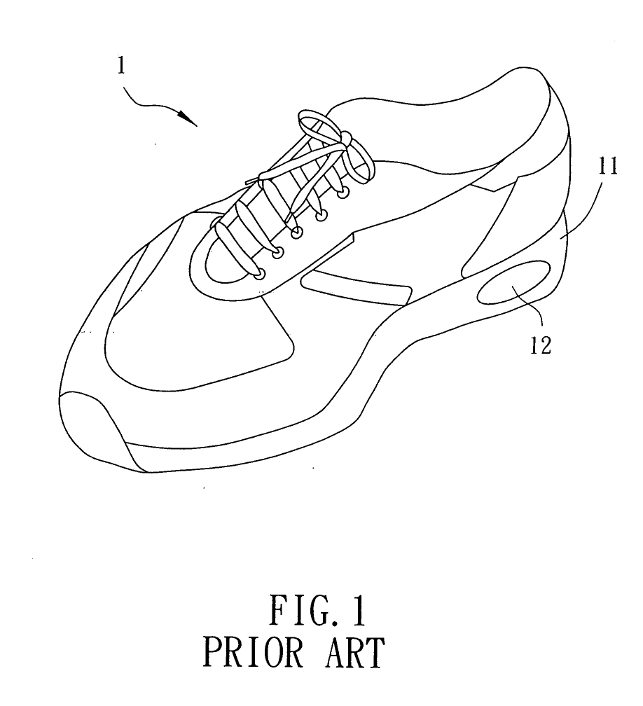

In use, when the composite unit 2 in the sole portion 13 of the shoe 10 is subjected to an external pressure, the relatively tough first outer tubes 211 of the first resilient elongate members 21 provide a good restoring force to the entire shock-absorbing device, and the first foam members 212 of the first resilient elongate members 21 provide good shock-absorbing and cushioning effects, thereby enhancing the shock-absorbing and buffering effects of the shock-absorbing device of the present invention. As compared to the conventional shock-absorbing device, i.e., the air-filled plastic cushion 12 of the conventional sports shoe 1 (see FIG. 1), the shock-absorbing device of the present invention not only provides a larger supporting force, but also has better shock-absorbing and buffering effects. Referring to FIG. 4, a resilient shock-absorbing device according to the second preferred embodiment of the present invention is shown to be similar to the first preferred embodiment. However, in this embodiment, the resilient shock-absorbing device of the present invention further comprises a cover 3 sleeved on and covering partially the composite unit 2′ and made of thermoplastic polyurethane. The cover 3 is in the form of an envelope having a single open end for access by the composite unit 2′. Also, in this embodiment, the first foam member 212′ of each first resilient elongate member 21′ has a first receiving space 213 formed in the middle of the first foam member 212′ and extending along the length thereof. Hence, each first foam member 212′ is hollow. Through the presence of the first receiving space 213 in each first foam member 212′, air can be filled in each first resilient elongate member 21′ to thereby enhance the buffering effect of the same.

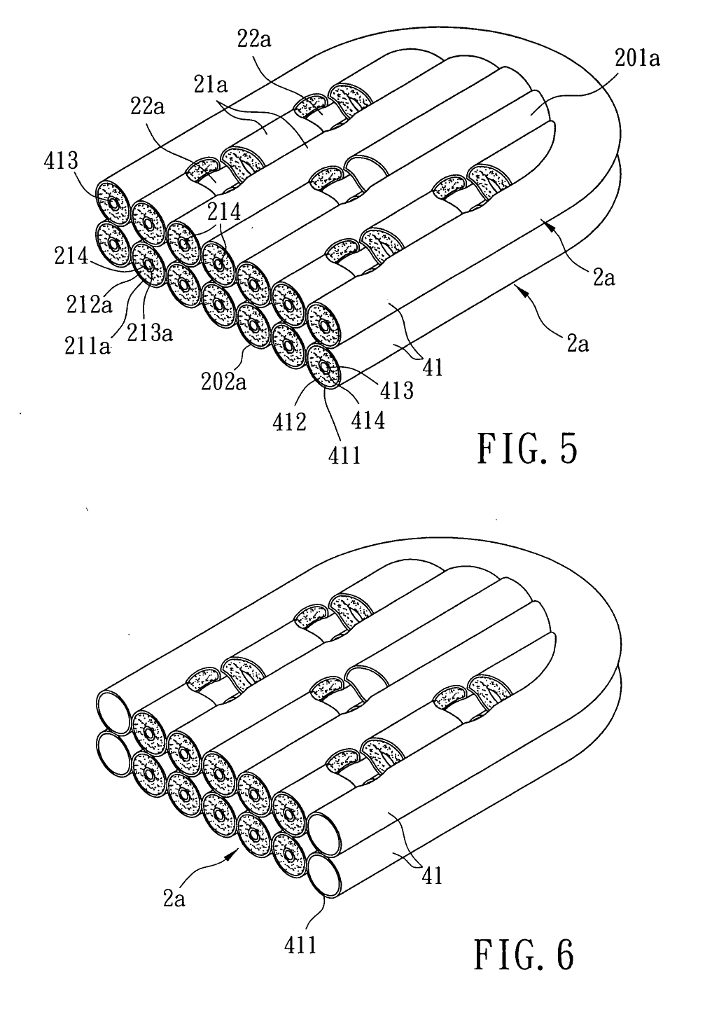

It should be noted that only one layer of the composite unit 2′ is disclosed in the second preferred embodiment. However, in actual application, the resilient shock-absorbing device may be provided with a plurality of layers of the composite units 2′ that are stacked together (see FIG. 5), and the cover 3 may be configured to cover partially all of the composite units 2′ in the stack and is not limited to the disclosed embodiment.

The composite unit 2′ of the second preferred embodiment is further formed with five spaced-apart through holes 22. Each of the through holes 22 extends through the top and bottom faces 201′, 202′ of the composite unit 2′, and may be configured to extend through one or more of the first resilient elongate members 21′. The number of the through holes 22 may be varied, and is not limited to the aforementioned disclosure.

In this embodiment, aside from the presence of the first receiving space 213 in each first foam member 212′ to enhance the buffering effect of each resilient elongate member 21′, the presence of the through holes 22 in the composite unit 2′ enhances the deformability of the composite unit 2′ when an external force is applied thereto. Such deformability may be varied. For example, if there is a large number of the through holes 22 in the composite unit 2′, the composite unit 2′ has a high deformability. In contrast, if there is a small number of the through holes 22 in the composite unit 2′, the composite unit 2′ is not easily deformed. The size of each through hole 22 also affects the deformability of the composite unit 2′.

Referring to FIGS. 5 and 6, a resilient shock-absorbing device according to the third preferred embodiment of the present invention is shown to comprise two layers of composite units (2a) which are superimposed and connected to each other. Since the structure of each layer of the composite units (2a) is similar, only one layer of the composite units (2a) will be described hereinafter.

The composite unit (2a) is similar to that described in the first preferred embodiment. However, in this embodiment, the first foam member (212a) of each first resilient elongate member (21a) defines a first receiving space (213a) that is formed in the middle of the first foam member (212a) and that extends along the length thereof. Hence, each first foam member (212a) is hollow. Each first resilient elongate member (21a) further has a first inner tube 214 inserted into the first receiving space (213a) in the first foam member (212a) thereof. The hardness of the first inner tube 214 of each first resilient elongate member (21a) ranges from 55 ShoreA to 85 ShoreD. The first inner tube 214, the first outer tube (211a), and the first foam member (212a) of each first resilient elongate member (21a) are made of the same thermoplastic polyurethane, so that their interconnection is strong.

The composite unit (2a) is further formed with five spaced-apart through holes (22a), which are similar to those described in the composite unit 2′ of the second preferred embodiment, and further has a second resilient elongate member 41 extending between the top and bottom faces (201a, 202a) of the composite unit (2a). The second resilient elongate member 41 is bent to have a substantially U-shape to surround the first resilient elongate members (21a). The number of the second resilient elongate member 41 may be varied, and is not limited to the disclosed embodiment. The second resilient elongate member 41 has a second outer tube 411, and a second foam member 412 disposed in the second outer tube 411 and extending along the length thereof. The second outer tube 411 and the second foam member 412 are made of thermoplastic polyurethane. Alternatively, the second resilient elongate member 41 may only have the second outer tube 411, and not include the second foam member 412, as shown in FIG. 6.

In this embodiment (i.e., the third preferred embodiment, as shown in FIG. 5), the second foam member 412 has a second receiving space 413 formed in the middle of the second foam member 412 and extending along the length thereof to thereby be hollow. The second resilient elongate member 41 further has a second inner tube 414 inserted into the second receiving space 413 and that is made of thermoplastic polyurethane. Each of the second outer and inner tubes 411, 414 has a hardness ranging from 55 ShoreA to 85 ShoreD. The density of the second foam member 412 ranges from 0.2 g/cm³ to 0.6 g/cm³.

Furthermore, through the presence of the first inner tubes 214 in the first receiving spaces (213a) of the first foam members (212a) of the first resilient elongate members (21a) of the composite units (2a), the supporting effect of the entire resilient shock-absorbing device of the present invention is strengthened, such that when an external force is greater than the limiting supporting force of the first outer tubes (211a) and the first foam members (212a) of the first resilient elongate members (21a), the first inner tubes 214 of the first resilient elongate members (21a) can provide an additional supporting force against the external force, thereby enhancing the supporting effect of the resilient shock-absorbing device of the present invention. Moreover, through the second resilient elongate member 41 that surrounds the first resilient elongate members (21a) of the corresponding composite unit (2a), the entire structure of the resilient shock-absorbing device of the present invention is strengthened, so that not only can buffering and supporting effects be achieved, but also the resilient shock-absorbing device of the present invention can simultaneously have high stability and durability. Hence, the structure of the third preferred embodiment is suitable for use in a product requiring high supporting and shock-absorbing effects.

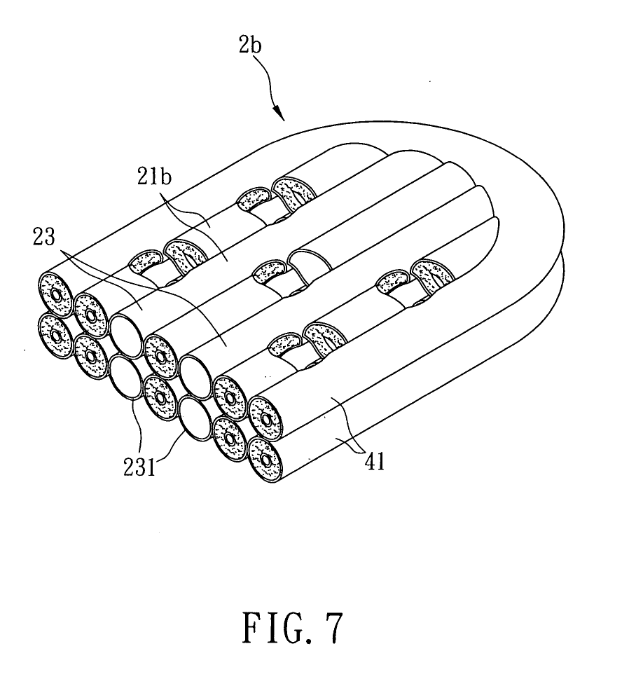

Referring to FIG. 7, a resilient shock-absorbing device according to the fourth preferred embodiment of the present invention is shown to be similar to the third preferred embodiment. However, in this embodiment, each composite unit (2b) further includes at least one third resilient elongate member 23 interposed between two of the first resilient elongate members (21b) of the corresponding composite unit (2b). The third resilient elongate member 23 has a third outer tube 231 that is made of thermoplastic polyurethane and that has a hardness ranging from 55 ShoreA to 85 ShoreD. The third outer tube 231 has nothing filled therein.

Preferably, two third outer tubes 231 are interposed between the first resilient elongate members (21b) of the corresponding composite unit (2b). Alternatively, arrangement of the third outer tubes 231 can be altered as desired to suit a product's requirements and to achieve different supporting and shock-absorbing effects.

From the aforementioned description, the advantages of the resilient shock-absorbing device of the present invention may be summarized as follows:

1. Since the first outer tube 211, 211′, (211a) and the first foam member 212, 212′, (212a) of each first resilient elongate member 21, 21′, (21a), (21b) are made of the same material, i.e., thermoplastic polyurethane, the bonding between the two is excellent.

2. Since the first resilient elongate members 21, 21′, (21a), (21b) are connected to each other in a parallel manner, in the presence of an external force, the first outer tubes 211, 211′, (211a), which have a relatively tough quality, provide a first stage of supporting effect. When the external force is larger than the threshold supportive value of the first outer tubes 211, 211′, (211a), the first outer tubes 211, 211′, (211a) deform and compress the first foam members 212, 212′, (212a). The first foam members 212, 212′, (212a), in turn, absorb the deforming force of the first outer tubes 211, 211′, (211a), and provide a second stage of buffering and shock-absorbing effects. The first receiving spaces 213, (213a) and the first inner tubes 214 provide additional buffering and shock-absorbing effects.

3. Since the thermoplastic polyurethane used in the shock-absorbing device is a recyclable material that may be reused and that can be decomposed, protection of the environment is achieved by using this material.

4. Each of the first outer tubes 211 provides for complete support and protection along the length thereof. Hence, when a portion of the composite unit 2, 2′, (2a), (2b) is damaged, it will not affect the shock-absorbing effect of the entire resilient shock-absorbing device. In contrast, when a portion of the conventional air-filled plastic cushion 12 (see FIG. 1) is damaged or has a leak, the shock-absorbing effect is adversely affected.

5. Since the resilient shock-absorbing device of the present invention is completely made of thermoplastic polyurethane, it can be easily bonded to other component parts by heating and pressing. Further, under a definite temperature, the shape of the resilient shock-absorbing device of the present invention can be altered as desired, including the ability to be bent to form any curve. While the thermoplastic polyurethane is used in the embodiments, the material used in the present invention should not be limited thereto. Other suitable rubber materials, such as natural rubber and silicone rubber may be used.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A resilient shock-absorbing device comprising:
at least one layer of a composite unit including top and bottom faces, and a plurality of juxtaposed and interconnected first resilient elongate members disposed between said top and bottom faces, each of said first resilient elongate members having a first outer tube, and a first foam member disposed in said first outer tube and extending along the length of said first outer tube.

2. The resilient shock-absorbing device of claim 1, wherein said first outer tube and said first foam member are made of thermoplastic polyurethane.

3. The resilient shock-absorbing device of claim 2, wherein said first outer tube has a hardness ranging from 55 ShoreA to 85 ShoreD.

4. The resilient shock-absorbing device of claim 2, wherein said first foam member has a density ranging from 0.2 g/cm³ to 0.6 g/cm³.

5. The resilient shock-absorbing device of claim 1, wherein said first foam member is hollow, and defines a first receiving space.

6. The resilient shock-absorbing device of claim 5, wherein said first receiving space is formed in the middle of said first foam member and extends along the length thereof, each of said first resilient elongate members further having a first inner tube inserted into said first receiving space.

7. The resilient shock-absorbing device of claim 1, wherein said composite unit has a through hole extending through said top and bottom faces and at least one of said first resilient elongate members.

8. The resilient shock-absorbing device of claim 1, further comprising a second resilient elongate member extending between said top and bottom faces and around said first resilient elongate members.

9. The resilient shock-absorbing device of claim 8, wherein said second resilient elongate member is bent to have a substantially U-shape.

10. The resilient shock-absorbing device of claim 8, wherein said second resilient elongate member has a second outer tube made of thermoplastic polyurethane, a second foam member disposed in said second outer tube and extending along the length of said second outer tube, and a second inner tube inserted into said second foam member.

11. The resilient shock-absorbing device of claim 10, wherein said second outer tube has a hardness ranging from 55 ShoreA to 85 ShoreD.

12. The resilient shock-absorbing device of claim 11, wherein said second foam member has a density ranging from 0.2 g/cm³ to 0.6 g/cm³.

13. The resilient shock-absorbing device of claim 1, wherein said composite unit further includes a third resilient elongate member interposed between two of said first resilient elongate members, said third resilient elongate member having a third outer tube made of thermoplastic polyurethane.

14. The resilient shock-absorbing device of claim 13, wherein said third outer tube has a hardness ranging from 55 ShoreA to 85 ShoreD.

15. The resilient shock-absorbing device of claim 1, further comprising a cover sleeved on and covering partially said composite unit and made of thermoplastic polyurethane.

16. The resilient shock-absorbing device of claim 1, wherein a plurality of layers of said composite units are arranged in a stack.
